(19) United States
(12) Patent Application Publication
(10) Pub. No.: US 2018/0311948 A1
(43) Pub. Date: Nov. 1, 2018

(54) Internal Ink Manifold

(71) Applicant: Goss International Americas, Inc., Durham, NH (US)

(72) Inventors: Daniel Paul Gagne, South Berwick, ME (US); James Vrotacoe, Barrington, NH (US); Michael Merry, Lee, NH (US)

(21) Appl. No.: 15/963,832

(22) Filed: Apr. 26, 2018

Related U.S. Application Data
(60) Provisional application No. 62/491,482, filed on Apr. 28, 2017.

(51) Int. Cl. B41F 31/02

(52) U.S. Cl. CPC B41F 31/02

(57) ABSTRACT

An inking system for a printing press is provided, including a structural member; an ink metering device mounted to the structural member; and an internal ink manifold housed in the structural member for supplying ink to the ink metering device.

### CROSS REFERENCE TO RELATED APPLICATION

Priority is hereby claimed to U.S. Provisional Application No. 62/491,482 filed Apr. 28, 2017, and hereby incorporated by reference herein.

### BACKGROUND

The present invention relates generally to inking devices and ink metering systems for printing presses.

As currently known in the art, ink metering systems utilize ink manifolds external to the support structure of the system to distribute the ink supply. When there is an open ink fountain, a manifold with a plurality of orifices resides over an ink trough separate from the support structure. A valve between the main ink supply and the manifold is open or closed to control to maintain a desired level of ink in the trough. When there is a closed ink metering device, ink is distributed from a separate ink manifold to the metering device or groups of metering devices (packs) via a series of fittings and hoses. The metering packs are then mounted to the structural member for distribution of ink to the print unit.

Cleaning the separate manifold is difficult and time consuming. To compensate for this, color specific manifold and distribution pumping is often utilized. A manifold is dedicated to one color. In open ink fountains ink colors may be changed, but the process is messy, time consuming and manual in nature. In addition, hand cleaning an internal manifold wastes ink and is labor intensive.

### BRIEF SUMMARY OF THE INVENTION

Separate manifolds are added to components of ink delivery systems which increase the cost and complexity of the system. In closed systems, ink in the manifold and distribution hoses is pressurized. Hoses expand under pressure and store energy (expanded elastomer) and ink (increased volume in expanded hoses). During idle periods, a valve between the manifold and main ink supply is closed trapping the pressurized ink. The stored energy in the hoses is relieved via ink leakage through the metering device. This results in startup issues, for example, when there is too much ink in the system, or increased maintenance, for example, ink on the floor. In addition, the assembly of the manifold, fittings and hoses is difficult to clean a change in ink color within a unit is desired.

Rigid piping has been considered to address the potential for leakage. This solution is not practical due to increased complexity and cost. A rigid ink distribution system would increase the difficulty of cleaning for color change.

### BRIEF DESCRIPTION OF THE DRAWINGS

A preferred embodiment of the present invention will be elucidated with reference to the drawings, in which:

FIGS. 1 to 3 show an inking system with an external manifold as known in the art; and

FIGS. 4 and 5 show an inking system with an internal manifold according to the present invention.

### DETAILED DESCRIPTION OF A PREFERRED EMBODIMENT

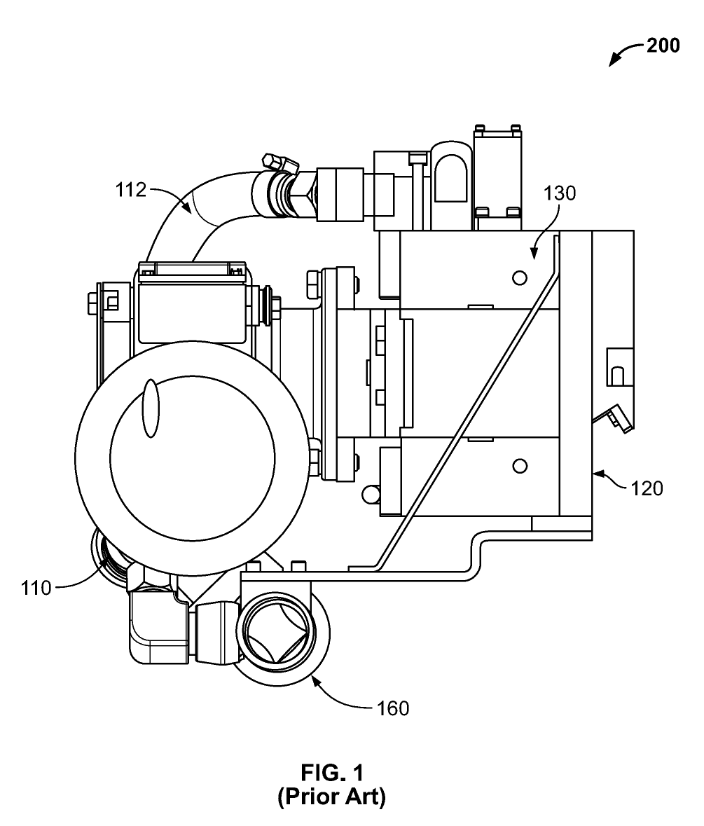

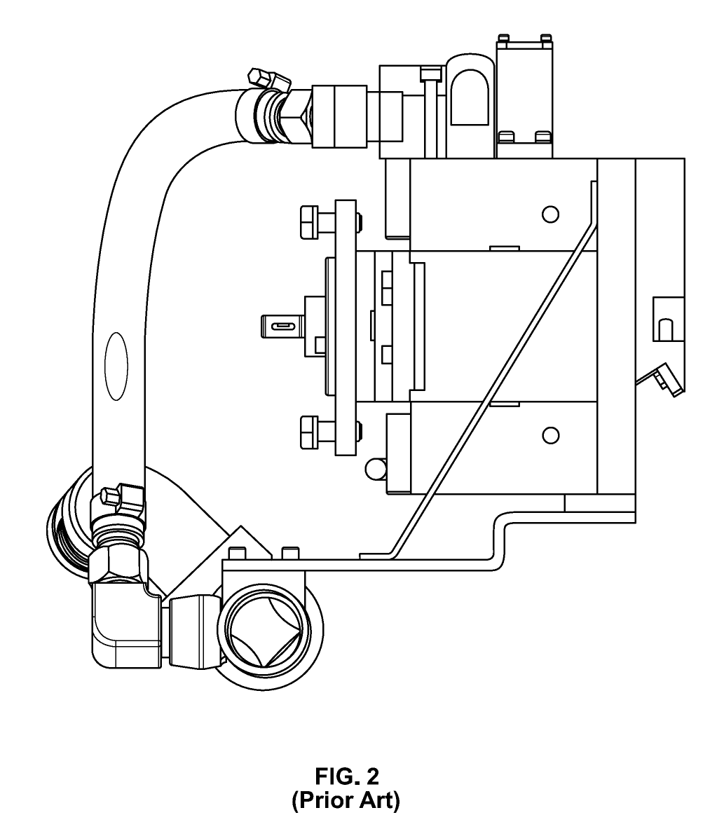

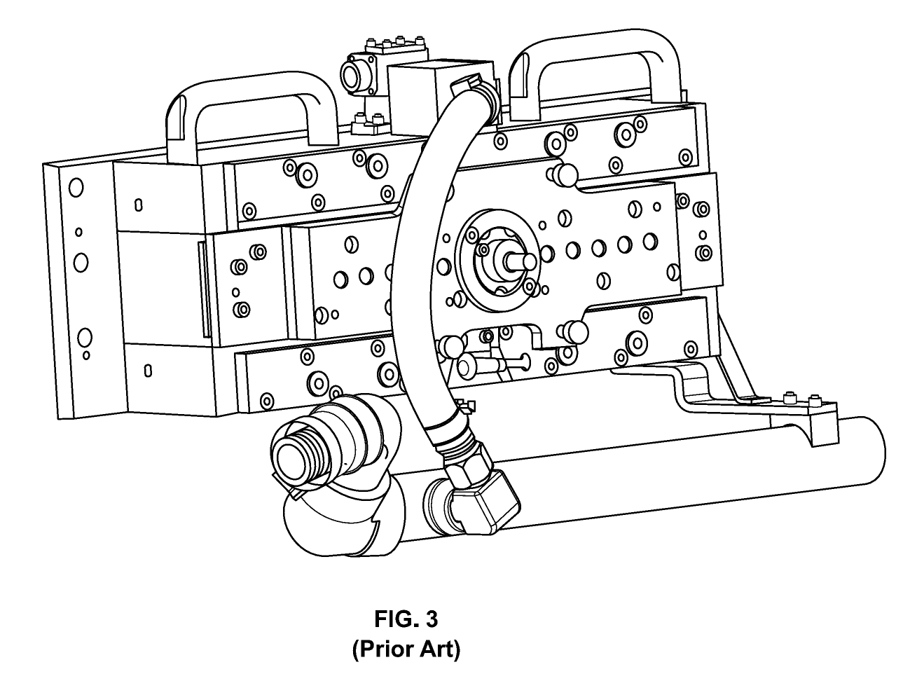

FIGS. 1 to 3 show an inking system having an external manifold 160 as known in the art. An ink supply 110 is connected to external manifold 160. A supply hose 112 connects external manifold 160 to ink metering device 130.

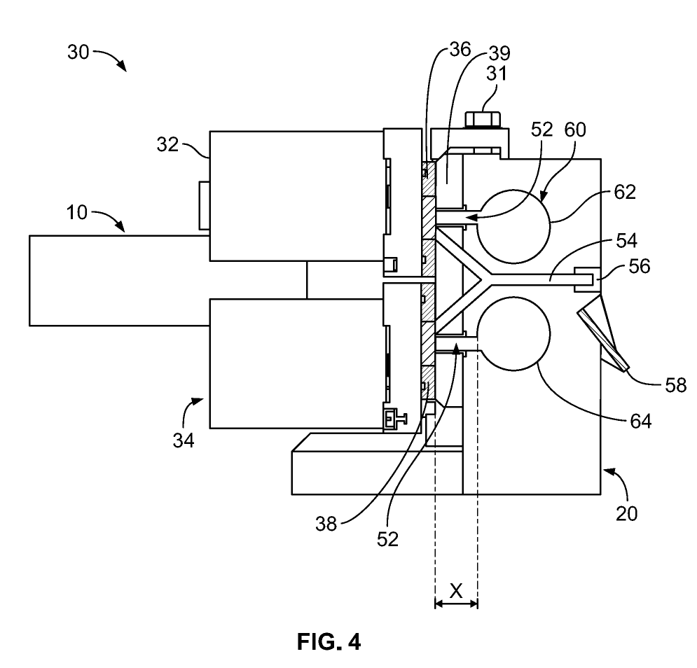

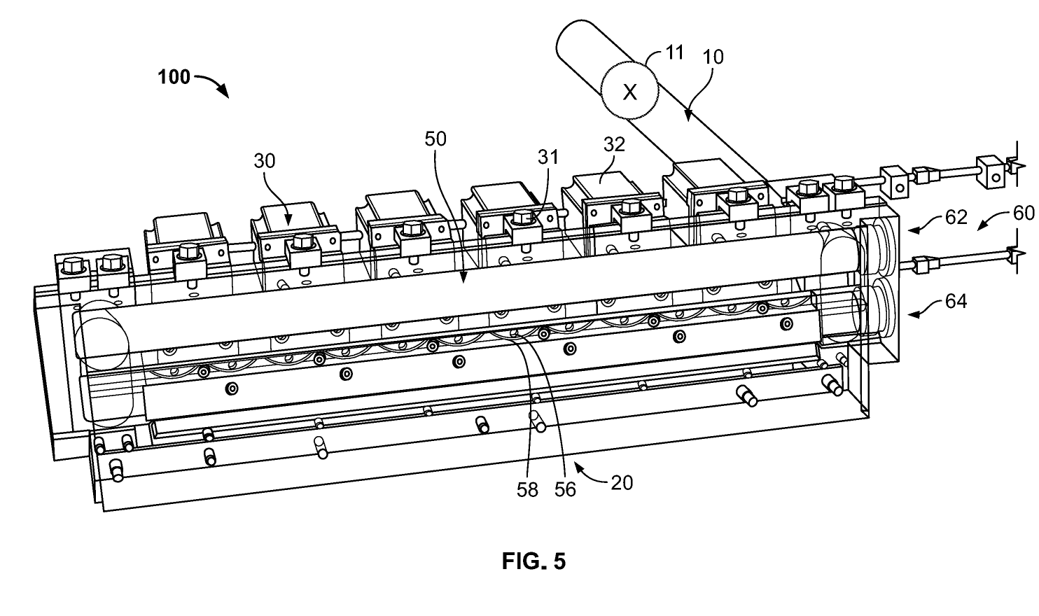

FIGS. 4 and 5 show an internal manifold for an ink metering device in accordance with the present invention. Inking system 100 includes an ink supply 10, a structural member 20, and removable ink metering devices 30 connected to structural member 20 via clamps 31. Structural member 20 includes a distribution rail 50 and internal manifold 60.

An internal manifold 60 is incorporated into distribution rail 50 of main structural member 20 which eliminates components and complexity of the inking system. Ink manifold 60 can be formed by extrusion, machined, a machined bore or a cast cavity, for example, internal to rail 50. Internal manifold includes an upper manifold chamber 62 and a lower manifold chamber 64 to improve flow while minimizing size.

Each removable ink metering device 30 includes two motors 32, 34 two pumps 36, 38 and a single wedge mounting plate 39 as shown in FIG. 4. Ports 52 connect upper manifold chamber 62 to pump 36 and lower manifold chamber 64 to pump 38, respectively.

Ink supply 10, which may be the main ink supply of inking system 100, is connected to internal manifold 60. A control valve 11 may be provided. Ink is distributed from supply 10 to each of the ink metering devices 30 via internal manifold 60.

During operation, ink enters inking system 100 via ink supply 10 and fills manifolds 62, 64 across a length of rail 50 under pressure from ink supply 10. The ink supply pressure is maintained at a sufficient level for the ink to flow from the ink supply 10 to and through the inter manifold chambers 62, 64. The ink moves from manifolds 62, 64 through ports 52. Motors 32, 34 and pumps 36, 38 pump ink via channels 54 to orifices 56. Ink exits structural member 20 through orifices 56 and is distributed to printing units therefrom.

Inking system 100 is simplified by the use of internal manifold 60 and with the elimination of the external manifold shown in FIGS. 1 to 3. Cleaning is improved with internal manifold 60 because fittings and hoses have been eliminated. The elimination of hoses eliminates a source of ink leakage during idle periods of the inking system. In addition, the rigid nature of the rail 50 eliminates the source of leakage from expanding hoses.

Another advantage of internal manifold 60 in inking system 100, is that a distance X from ink supply of upper and lower manifolds 62, 64 to pumps 36, 38, respectively, is reduced. Distance X is critical and is desired to be as short as possible in order to minimize the amount of ink that needs to be flushed out during a color change and to decrease restriction during periods of high demand and high flow. Internal manifold 60 places the ink as close to pump 36, 38 as physically possible.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. An inking system for a printing press comprising:
a structural member;
an ink metering device mounted to the structural member; and
an internal ink manifold housed in the structural member for supplying ink to the ink metering device.

2. The inking system as recited in claim 1 further comprising an ink supply connected to the internal ink manifold.

3. The inking system as recited in claim 2 further comprising a control valve between the internal ink manifold and ink supply.

4. The inking system as recited in claim 1, wherein the internal ink manifold is connected to the ink metering device via a port.

5. The inking system as recited in claim 1 wherein the internal ink manifold is formed by extrusion, a machined bore, machined or a cast cavity internal to the structural member.

6. The inking system as recited in claim 1 further comprising a further or a plurality of ink metering devices mounted to the structural member.

7. A printing press comprising:
at least one printing unit; and
an inking system according to claim 1 for providing ink to the at least one printing unit.
